(19) United States
(12) Patent Application Publication
(10) Pub. No.: US 2015/0286063 A1
(43) Pub. Date: Oct. 8, 2015

(54) 3D GLASSES, CURVED SURFACE DISPLAY AND 3D DISPLAY APPARATUS

(71) Applicant: SHENZHEN CHINA STAR OPTOELETRONICS TECHNOLOGY CO., LTD.,, Shenzhen, Guangdong (CN)

(72) Inventors: Zuomin Liao, Shenzhen (CN); Bing Han, Shenzhen (CN)

(21) Appl. No.: 14/375,729

(22) PCT Filed: Apr. 30, 2014
(86) PCT No.: PCT/CN2014/076624

§ 371 Date: Jul. 30, 2014

(30) Foreign Application Priority Data
Apr. 8, 2014 (CN) 2014101138756.2

(51) Int. Cl. G02B 27/22; G02B 27/26

(52) U.S. Cl. CPC G02B 27/2228; G02B 27/26

(57) ABSTRACT

The present disclosure relates to the technical field of display, in particular to 3D glasses, a curved surface display and a 3D display apparatus, whereby the technical problem that the display effect of 3D display is affected due to mutual interference between left and right eyes can be solved. The 3D glasses is provided for use with a curved surface display to realize 3D display, including a film patterned retarder, wherein the film patterned retarder is configured in such a way that, the ratios of the distances that light paths from different points on the curved surface display to a set point pass through the film patterned retarder to the distances that said light paths pass through a film patterned retarder of the curved surface display are identical or approximately identical. The present disclosure is suitable for LCD television, LCD monitor, etc.

### FIELD OF THE INVENTION

The present disclosure relates to the technical field of display, in particular to 3D glasses, a curved surface display and a 3D display apparatus.

### BACKGROUND OF THE INVENTION

A curved surface display is provided with a screen having a curved surface. In this display, each pixel on the screen is equally distanced from human eyes, so that it can vividly restore real visual perception of the human eyes. Therefore, the curved surface display is more competitive than a traditional flat panel display. Meanwhile, when the curved surface screen is used for 3D display, the feeling of reality of images displayed may be enhanced. 3D display can be realized by means of film patterned retarder (FPR for short), which has the advantages of no flicker, high brightness, high refresh rate and the like. Consequently, FPR has been frequently used in the field of 3D display already.

The arc center of the curved surface display is a position with the best view angle, which is taken as an example for illustration herein. As shown in FIG. 1, in the prior art, a film patterned retarder 20 with a curved surface is arranged on a substrate 21 of a curved surface display 2, and a planar film patterned retarder 10 is arranged on each lens 11 of 3D glasses 1. Generally, human eyes are positioned at the arc center O of the curved surface display 2. During 3D display, when a viewer views different points, e.g., three points A, B and C shown in FIG. 1, on the curved surface display 2 from the arc center O, interference will be generated between left and right eyes. Namely, the left eye will see the image that should be viewed by the right eye, while the right eye will see the image that should be viewed by the left eye. Therefore, the display effect of 3D display is affected.

### SUMMARY OF THE INVENTION

The present disclosure aims to provide 3D glasses, a curved surface display and a 3D display apparatus, for the purpose of solving the technical problem that the display effect of 3D display is affected due to mutual interference between left and right eyes in the prior art.

The present disclosure provides 3D glasses for use with a curved surface display to realize 3D display, including a film patterned retarder. The film patterned retarder is configured in such a way that, the ratios of the distances that light paths from different points on the curved surface display to a set point pass through the film patterned retarder to the distances that said light paths pass through a film patterned retarder of the curved surface display are identical or approximately identical.

In an embodiment, the film patterned retarder of the 3D glasses is curved, and the thickness of the film patterned retarder is uniform.

In another embodiment, the film patterned retarder of the 3D glasses is planar, and the thickness of the film patterned retarder is gradually increased from both ends to the middle thereof.

In a further embodiment, the film patterned retarder of the 3D glasses is curved, and the thickness of the film patterned retarder is gradually increased from both ends to the middle thereof.

Preferably, the set point is located on a normal plane where the central point of the curved surface display is located.

Further, the set point is located at the arc center of the curved surface display.

Further, the 3D glasses further include a polarizer laminated with the film patterned retarder.

The present disclosure further provides a 3D display apparatus, including a curved surface display and the above-mentioned 3D glasses, wherein the curved surface display includes a film patterned retarder having a curved surface.

The present disclosure further provides a curved surface display for use with 3D glasses to realize 3D display, including a film patterned retarder having a curved surface. The film patterned retarder is configured in such a way that, the ratios of the distances that light paths from different points on the curved surface display to a set point pass through the film patterned retarder to the distances that said light paths pass through a film patterned retarder in the 3D glasses are identical or approximately identical.

Preferably, the thickness of the film patterned retarder in the curved surface display is reduced from both ends to the middle thereof.

Preferably, the set point is located on a normal plane where the central point of the curved surface display is located.

Further, the set point is located at the arc center of the curved surface display.

Further, the curved surface display further includes a polarizer laminated with the film patterned retarder.

The present disclosure further provides another 3D display apparatus, including 3D glasses and the above-mentioned curved surface display, wherein the 3D glasses include a film patterned retarder.

One or more embodiments of the present disclosure at least generate the following advantages. When the 3D glasses according to the present disclosure are cooperatively used with a curved surface display, the ratios of the distances that the light paths from different points on the curved surface display to the set point (where human eyes are located) pass through the film patterned retarder in the 3D glasses to the distances that said light paths pass through the film patterned retarder in the curved surface display are identical or approximately identical. Therefore, the technical problem of mutual interference between left and right eyes can be solved, and the display effect of 3D display can be improved.

When the curved surface display according to the present disclosure is cooperatively used with the 3D glasses, the ratios of the distances that the light paths from different points on the curved surface display to the set point (where human eyes are located) pass through the film patterned retarder in the curved surface display to the distances that said light paths pass through the film patterned retarder in the 3D glasses are identical or approximately identical. Therefore, the technical problem of mutual interference between left and right eyes can be solved, and the display effect of 3D display can be improved.

Other features and advantages of the present disclosure will be set forth in the following description, and in part will be made obvious from the description, or be self-evident by implementing the present disclosure. The objectives and other advantages of the present disclosure may be achieved and obtained by structures particularly pointed out in the description, the claims and the accompanying drawings.

### BRIEF DESCRIPTION OF THE DRAWINGS

To illustrate the technical solutions in the embodiments of the present disclosure or in the prior art more clearly, a brief introduction on the accompanying drawings which are necessary for illustrating the embodiments or the prior art is provided below.

FIG. 1 is a schematic diagram of a light path of a conventional curved surface display and 3D glasses;

FIG. 2 is a schematic diagram of a light path of 3D glasses provided in Embodiment I of the present disclosure;

FIG. 3 is a schematic diagram of a light path of 3D glasses provided in Embodiment II of the present disclosure;

FIG. 4 is a schematic diagram of a light path of a curved surface display provided in Embodiment III of the present disclosure.

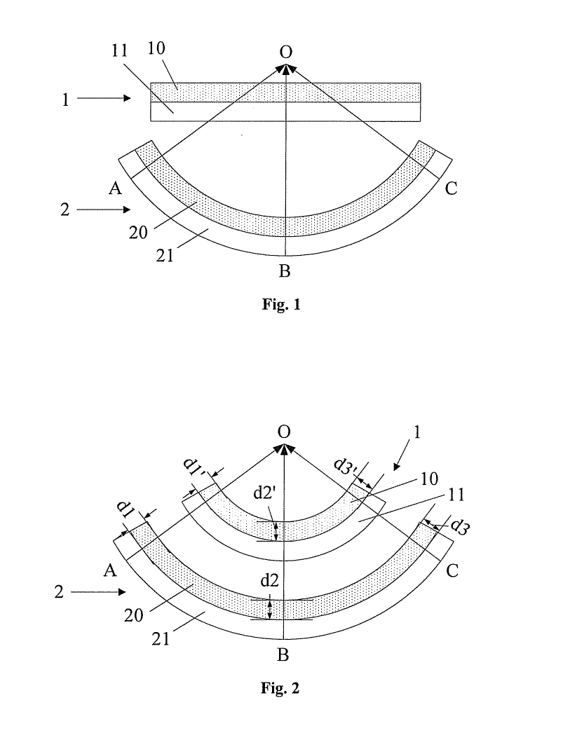

### DETAILED DESCRIPTION OF THE EMBODIMENTS

A detailed description of the implementation modes of the present disclosure will be given below, in combination with the accompanying drawings and embodiments, whereby an implementation process of how to use technical means of the present disclosure to solve the technical problems and achieve a technical effect may be fully understood and then implemented accordingly. It should be noted that, as long as no conflict is generated, various embodiments of the present disclosure and various features of the embodiments may be combined with each other, and the formed technical solutions are all within the protection scope of the present disclosure.

An embodiment of the present disclosure provides 3D glasses for use with a curved surface display to realize 3D display, including a film patterned retarder. The film patterned retarder is configured in such a way that, the ratios of the distances that light paths from different points on the curved surface display to a set point pass through the film patterned retarder to the distances that said light paths pass through a film patterned retarder of the curved surface display are identical or approximately identical.

When the 3D glasses according to the present disclosure are cooperatively used with the curved surface display, the ratios of the distances that the light paths from different points on the curved surface display to the set point (where human eyes are located) pass through the film patterned retarder in the 3D glasses to the distances that said light paths pass through the film patterned retarder in the curved surface display are identical or approximately identical. Therefore, the technical problem of mutual interference between left and right eyes can be solved, and the display effect of 3D display can be improved.

### Embodiment I

As shown in FIG. 2, the 3D glasses 1 provided by this embodiment include a film patterned retarder 10 having a curved surface, and the thickness of the film patterned retarder 10 is equal along its length. The film patterned retarder 10 is generally laminated on a glass or resin lens 11, which, in this embodiment, is preferably in a curved surface shape and has the same shape as the film patterned retarder 10. The 3D glasses 1 may further include a polarizer (not shown in the figure) laminated with the film patterned retarder 10.

The arc center of the curved surface display is a position with the best view angle, and this embodiment will be illustrated by taking this condition as an example. As shown in FIG. 2, the 3D glasses 1 provided by the embodiment of the present disclosure may be cooperatively used with a traditional curved surface display 2. A film patterned retarder 20 having a curved surface is arranged on a substrate 21 of the curved surface display 2. Human eyes are located at the arc center O of the curved surface display 2, namely, a set point, which is preferably the arc center of the 3D glasses 1 also. The distances that light paths AO, BO and CO of light from three pixels A, B and C on the curved surface display 2 to the human eyes pass through the film patterned retarder 20 are defined as d1, d2 and d3 respectively, and the distances that said light paths AO, BO and CO pass through the film patterned retarder 10 are defined as d1′, d2′ and d3′ respectively. Since the point O is the arc center of the curved surface display 2, the light paths AO, BO and CO each exits along a direction vertical to the tangential direction of the film patterned retarder 20, and since the thicknesses of the film patterned retarder 20 are equal along its length, then d1=d2=d3. Since the point O is also the arc center of the 3D glasses 1, the light paths AO, BO and CO each enters the 3D glasses 1 along a direction vertical to the tangential direction of the film patterned retarder 10, and since the thicknesses of the film patterned retarder 10 are equal along its length, then d1′=d2′=d3′. Thus, in the embodiment of the present disclosure, it can be concluded that d1/d1′=d2/d2′=d3/d3′, so that the ratios of the distances that light in different angles passes through the film patterned retarders 20 and 10 are equal. Consequently, the technical problem of mutual interference between left and right eyes is solved, and the display effect of 3D display is improved.

When the relative position between the 3D glasses 1 and the curved surface display 2 changes, the distances that the light passes through the film patterned retarder 10 and that passes through the film patterned retarder 20 will slightly change. However, the ratios of the distances that the light passes through the film patterned retarder 10 and that passes through the film patterned retarder 20 may still be kept approximately identical. Therefore, the phenomenon of mutual interference between the left and right eyes is eliminated.

It should be noted that, in other implementation modes, the position of the set point may also be changed. Generally, the set point may be located on a normal plane where the central point of the curved surface display is located. In this case, when the curvature of the film patterned retarder in the 3D glasses is appropriately adjusted, the technical problem of mutual interference between the left and right eyes can be solved, and the display effect of 3D display can be improved.

### Embodiment II

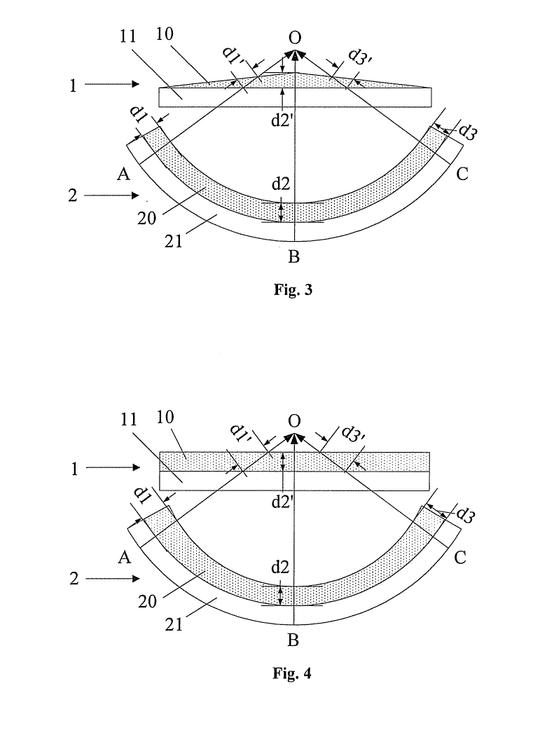

As shown in FIG. 3, in the 3D glasses 1 provided by this embodiment, the film patterned retarder 10 is laminated on a resin lens 11. Both of the film patterned retarder 10 and the lens 11 are planar, and the thickness of the film patterned retarder 10 is gradually increased from both ends to the middle. Moreover, the 3D glasses 1 may further include a polarizer (not shown in the figure) laminated with the film patterned retarder 10.

The arc center of the curved surface display is a position with the best view angle, and this embodiment will be illustrated by taking this condition as an example. As shown in FIG. 3, the 3D glasses 1 provided by this embodiment of the present disclosure may be cooperatively used with a traditional curved surface display 2. A film patterned retarder 20 having a curved surface is arranged on a substrate 21 of the curved surface display 2. Human eyes are located at the arc center O of the curved surface display 2, namely, a set point. The distances that light paths AO, BO and CO of light from three pixels A, B and C on the curved surface display 2 to the human eyes pass through the film patterned retarder 20 are defined as d1, d2 and d3 respectively, and the distances that said light paths AO, BO and CO pass through the film patterned retarder 10 are defined as d1′, d2′ and d3′ respectively. Since the point O is the arc center of the curved surface display 2, the light paths AO, BO and CO each exits along a direction vertical to the tangential direction of the film patterned retarder 20, and since the thicknesses of the film patterned retarder 20 are equal along its length, then d1=d2=d3. The light path OB vertically enters the film patterned retarder 10, and the light paths OA and OC obliquely enter the film patterned retarder 10. However, since the film patterned retarder 10 is relatively thin at OA and OC, then d1′=d2′=d3′. Thus, in the embodiment of the present disclosure, it can be concluded that d1/d1′=d2/d2′=d3/d3′, so that the ratios of the distances that light in different angles passes through the film patterned retarders 20 and 10 are equal. Consequently, the technical problem of mutual interference between left and right eyes is solved, and the display effect of 3D display is improved.

When the relative position between the 3D glasses 1 and the curved surface display 2 changes, the distances that the light passes through the film patterned retarder 10 and that passes through the film patterned retarder 20 will slightly change. However, the ratios of the distances that the light passes through the film patterned retarder 10 and that passes through the film patterned retarder 20 may still be kept approximately identical. Therefore, the phenomenon of mutual interference between the left and right eyes is eliminated.

It should be noted that, in other implementation modes, the position of the set point may also be changed. Generally, the set point may be located on a normal plane where the central point of the curved surface display is located. In this case, when the curvature of the film patterned retarder in the 3D glasses is appropriately adjusted, the technical problem of mutual interference between the left and right eyes can be solved, and the display effect of 3D display can be improved.

In addition to the above-mentioned implementation mode, Embodiment I may also be combined with Embodiment II, so that the film patterned retarder in the 3D glasses has a certain curvature, with the thickness thereof being gradually increased from both ends to the middle thereof. In this case, however, the changing rates of the curvature and thickness of the film patterned retarder should be appropriately reduced.

The embodiment of the present disclosure further provides a curved surface display for use with 3D glasses to realize 3D display, including a film patterned retarder having a curved surface. The film patterned retarder is configured in such a way that, the ratios of the distances that light paths from different points on the curved surface display to a set point pass through the film patterned retarder to the distances that said light paths pass through a film patterned retarder in the 3D glasses are identical or approximately identical.

When the curved surface display according to the present disclosure is cooperatively used with the 3D glasses, the ratios of the distances that the light paths from different points on the curved surface display to the set point (where human eyes are located) pass through the film patterned retarder in the curved surface display to the distances that said light paths pass through the film patterned retarder in the 3D glasses are identical or approximately identical. Therefore, the technical problem of mutual interference between left and right eyes can be solved, and the display effect of 3D display can be improved.

### Embodiment III

As shown in FIG. 4, a curved surface display 2 provided by the embodiment of the present disclosure includes a curved substrate 21 and a film patterned retarder 20, wherein the thickness of the film patterned retarder 20 is gradually reduced from both ends to the middle thereof. Moreover, the curved surface display 2 may further include a polarizer (not shown in the figure) laminated with the film patterned retarder 20.

The arc center of the curved surface display is a position with the best view angle, and this embodiment is illustrated by taking this condition as an example. As shown in FIG. 3, the curved surface display 2 provided by the embodiment of the present disclosure may be cooperatively used with a traditional 3D glasses 1. The 3D glasses 1 include a planar lens 11 and a film patterned retarder 10. Human eyes are located at the arc center O of the curved surface display 2, namely, a set point. The distances that light paths AO, BO and CO of light from three pixels A, B and C on the curved surface display 2 to the human eyes pass through the film patterned retarder 20 are defined as dl, d2 and d3 respectively, and the distances that said light paths AO, BO and CO pass through the film patterned retarder 10 are defined as d1′, d2′ and d3′ respectively. Since the point O is the arc center of the curved surface display 2, the light paths AO, BO and CO each exits along a direction vertical to the tangential direction of the film patterned retarder 20. However, since the thickness of the film patterned retarder 20 is gradually reduced from both ends to the middle thereof, d1 and d3 are longer while d2 is shorter. Namely, each of d1 and d3 is greater than d2. The light path OB vertically enters the film patterned retarder 10, and the light paths OA and OC obliquely enter the film patterned retarder 10, so that d1′ and d3′ are longer while d2′ is shorter. Namely, each of d1′ and d3′ is greater than d2′. Thus, in the embodiment of the present disclosure, the relationship of d1/d1′=d2/d2′=d3/d3′ can be still satisfied, so that the ratios of the distances that light in different angles passes through the film patterned retarders 20 and 10 are equal. Consequently, the technical problem of mutual interference between left and right eyes is solved, and the display effect of 3D display is improved.

When the relative position between the 3D glasses 1 and the curved surface display 2 changes, the distances that the light passes through the film patterned retarder 10 and that passes through the film patterned retarder 20 will slightly change. However, the ratios of the distances that the light passes through the film patterned retarder 10 and that passes through the film patterned retarder 20 may still be kept approximately identical. Therefore, the phenomenon of mutual interference between the left and right eyes is eliminated.

It should be noted that, in other implementation modes, the position of the set point may also be changed. Generally, the set point may be located on a normal plane where the central point of the curved surface display is located. In this case, when the curvature of the film patterned retarder in the 3D glasses is appropriately adjusted, the technical problem of mutual interference between the left and right eyes can be solved, and the display effect of 3D display can be improved.

### Embodiment IV

This embodiment of the present disclosure provides a 3D display apparatus, which may include a curved surface display and the 3D glasses according to Embodiment I or Embodiment II. The curved surface display may be a traditional curved surface display, which is provided with a curved film patterned retarder with uniform thickness.

The 3D display apparatus provided by the embodiment of the present disclosure may also include 3D glasses and the curved surface display according to Embodiment III. The 3D glasses may be traditional 3D glasses, which are provided with a planar film patterned retarder with uniform thickness.

The 3D display apparatus provided by the embodiment of the present disclosure may also include the 3D glasses according to Embodiment I or Embodiment II, and the curved surface display according to Embodiment III. Of course, the curvature and thickness of the film patterned retarder in the 3D glasses and the thickness of the film patterned retarder in the curved surface display should be adjusted correspondingly, so that the ratios of the distances that light in different angles passes through the two film patterned retarders are identical or approximately identical.

The 3D display apparatus provided by this embodiment of the present disclosure possesses the same technical features as the 3D glasses provided by Embodiment I or Embodiment II or the curved surface display provided by Embodiment III. Therefore, the same technical problem can be solved, and the same technical effect can be achieved.

Although the implementation modes provided by the present disclosure are described above, they are those merely adopted to facilitate understanding of the present disclosure, rather than limiting the present disclosure. Any skilled in the art to which the present disclosure pertains may make any modifications and variations on implementation forms and details without departing from the disclosed spirit and scope of the present disclosure. The scope of the present disclosure shall be subject to the scope defined by the appended claims.

1. 3D glasses for use with a curved surface display to realize 3D display, including a film patterned retarder, wherein the film patterned retarder is configured in such a way that, the ratios of the distances that light paths from different points on the curved surface display to a set point pass through the film patterned retarder to the distances that said light paths pass through a film patterned retarder of the curved surface display are identical or approximately identical.

2. The 3D glasses according to claim 1, wherein the film patterned retarder of the 3D glasses is curved, and the thickness of the film patterned retarder is uniform.

3. The 3D glasses according to claim 1, wherein the film patterned retarder of the 3D glasses is planar, and the thickness of the film patterned retarder is gradually increased from both ends to the middle thereof.

4. The 3D glasses according to claim 1, wherein the film patterned retarder of the 3D glasses is curved, and the thickness of the film patterned retarder is gradually increased from both ends to the middle thereof.

5. The 3D glasses according to claim 1, wherein the set point is located on a normal plane where the central point of the curved surface display is located.

6. The 3D glasses according to claim 5, wherein the set point is located at the arc center of the curved surface display.

7. The 3D glasses according to claim 1, wherein the 3D glasses further include a polarizer laminated with the film patterned retarder.

8. A curved surface display for use with 3D glasses to realize 3D display, including a film patterned retarder having a curved surface, wherein the film patterned retarder is configured in such a way that, the ratios of the distances that light paths from different points on the curved surface display to a set point pass through the film patterned retarder to the distances that said light paths pass through a film patterned retarder in the 3D glasses are identical or approximately identical.

9. The curved surface display according to claim 1, wherein the thickness of the film patterned retarder in the curved surface display is reduced from both ends to the middle thereof.

10. The curved surface display according to claim 8, wherein the set point is located on a normal plane where the central point of the curved surface display is located.

11. The curved surface display according to claim 10, wherein the set point is located at the arc center of the curved surface display.

12. The curved surface display according to claim 8, wherein the curved surface display further includes a polarizer laminated with the film patterned retarder.

13. A 3D display apparatus, including 3D glasses and a curved surface display each having a film patterned retarder, the 3D glasses and the curved surface display being cooperate with each other to realize 3D display,
wherein the film patterned retarder of the 3D glasses is configured in such a way that, the ratios of the distances that light paths from different points on the curved surface display to a set point pass through the film patterned retarder to the distances that said light paths pass through the film patterned retarder of the curved surface display are identical or approximately identical, or
the film patterned retarder of the curved surface display is configured in such a way that, the ratios of the distances that light paths from different points on the curved surface display to a set point pass through the film patterned retarder to the distances that said light paths pass through the film patterned retarder of the 3D glasses are identical or approximately identical.
